(19) United States
(12) Patent Application Publication
(10) Pub. No.: US 2021/0208538 A1
(43) Pub. Date: Jul. 8, 2021

(54) MOVEMENT AND WATCH

(71) Applicant: Seiko Epson Corporation, Tokyo (JP)

(72) Inventor: Masashi Takano, Shiojiri (JP)

(21) Appl. No.: 17/143,209

(22) Filed: Jan. 7, 2021

(30) Foreign Application Priority Data
Jan. 8, 2020 (JP) 2020-001304
Sep. 14, 2020 (JP) 2020-153586

(51) Int. Cl. G04B 19/253

(52) U.S. Cl. CPC G04B 19/2536

(57) ABSTRACT

A movement of the present disclosure is provided with an hour wheel, and a date indicator that includes a calendar plate and a date gear portion provided with a plurality of toothed portions on an inner circumferential side of the calendar plate. The movement is provided with a date jumper including a jump regulating portion that engages with adjacent toothed portions, of the plurality of toothed portions, to regulate rotation of the date indicator. The jump regulating portion includes a first regulating face that, of the adjacent toothed portions, engages with one of the toothed portions, a second regulating face that engages with the other of the toothed portions, and a coupling face provided between the first regulating face and the second regulating face, and is configured to be engageable with and disengageable from the adjacent toothed portions.

The present application is based on and claims priority from JP Application Serial Number 2020-001304, filed Jan. 8, 2020, and JP Application Serial Number 2020-153586, filed Sep. 14, 2020, the disclosures of which are hereby incorporated by reference herein in their entirety.

### BACKGROUND

### 1. Technical Field

The present disclosure relates to a movement and a watch.

### 2. Related Art

In JP-A-2018-4440, a watch provided with a calendar mechanism is disclosed. In the watch disclosed in JP-A-2018-4440, a configuration is adopted in which the date can be switched once a day, by intermittently driving a date indicator on which a numerical character indicating the date is displayed, using a date indicator driving wheel and a date jumper.

However, in the watch disclosed in JP-A-2018-4440, it is necessary to rotate the date indicator using the date indicator driving wheel while depressing the date jumper against an urging force thereof. Thus, when it is attempted to release regulation by the date jumper at 24:00 hours, it is necessary to rotate the date indicator from 1 to 2 hours in advance, and to gradually release the regulation by the date jumper. Then, during the rotation of the date indicator, there is a problem in that a portion of the date displayed on the date indicator becomes displaced from a date window, and the appearance thereof deteriorates.

### SUMMARY

Therefore, with respect to JP-A-2018-4440, it is conceivable to provide, on the date indicator driving wheel, an elastic portion that can store the urging force used to rotate the date indicator, in order to switch the date in a short time period. In other words, it is conceivable to switch the date in the short time period by rotating the date indicator using the urging force, by storing the urging force in the elastic portion of the date indicator driving wheel and rotating the date indicator using that urging force when a toothed portion of the date indicator moves beyond a regulating face of a tip end portion of the date jumper.

However, in this case also, since a portion of the date displayed on the date indicator becomes displaced from the date window from the start of the rotation of the date indicator to when the toothed portion of the date indicator moves beyond the regulating face of the tip end portion of the date jumper, the appearance deteriorates.

In JP-A-2018-4440, in order to shorten the time from when the date indicator starts rotating to when the toothed portion of the date indicator moves beyond the regulating face of the tip end portion of the date jumper, it is also conceivable to make an angle of the regulating face steeper, but in this case, an angle of a face that forms a counterpart with the regulating face of the tip end portion of the date jumper becomes more gentle, and a force with which this face regulates the rotation of the date indicator is weakened. In this case, for example, when the watch is subject to an impact, such as when the watch is dropped or the like, there is a risk that the regulation of the rotation of the date indicator by the date jumper may become disengaged, and the display of the date may be displaced.

Thus, there is demand for a movement and a watch capable of switching the date in a short time period and suppressing inadvertent rotation of the date indicator.

A movement according to an aspect of the present disclosure includes an hour wheel, and a date indicator including a calendar plate provided in an annular shape and on which is marked a numeral character indicating a date and a date gear portion including a plurality of toothed portions provided at an inner circumferential side of the calendar plate. The movement includes a date indicator driving wheel including a date indicator gear portion configured to engage with the hour wheel and to which rotation of the hour wheel is transmitted, a date main body portion configured to rotate integrally with the date indicator gear portion, an elastic portion extending from the date main body portion and configured to urge the date indicator in a rotational direction, and a date finger provided at a tip end of the elastic portion and configured to engage with the toothed portion of the date gear portion. The movement includes a date jumper including a jump regulating portion configured to engage with adjacent toothed portions, of the plurality of toothed portions, to regulate rotation of the date indicator. The jump regulating portion includes a first regulating face that, of the adjacent toothed portions, engages with one of the toothed portions, a second regulating face that engages with the other of the toothed portions, and a coupling face provided between the first regulating face and the second regulating face, the jump regulating portion being configured to be engageable with and disengageable from the adjacent toothed portions. The date indicator rotates by one pitch of meshing between the toothed portions and the jump regulating portion, by rotating, in accordance with the rotation of the hour wheel transmitted by the date indicator driving wheel, in a state in which the one of the toothed portions and the coupling face are in contact with each other, subsequently rotating, in accordance with an urging force of the elastic portion, in a state in which the one of the toothed portions and the coupling face are in contact with each other, and further subsequently rotating in a state in which the one of the toothed portions and the second regulating face are in contact with each other.

A watch according to an aspect of the present disclosure includes the above-described movement.

### BRIEF DESCRIPTION OF THE DRAWINGS

FIG. 1 is a front view illustrating a watch according to a first embodiment.

FIG. 2 is a diagram illustrating main portions of a movement according to the first embodiment.

FIG. 3 is a plan view illustrating a date indicator according to the first embodiment.

FIG. 4 is a cross-sectional view taken along a line IV-IV illustrated in FIG. 3.

FIG. 5 is a plan view illustrating a date indicator driving wheel according to the first embodiment.

FIG. 6 is a plan view illustrating a date jumper according to the first embodiment.

FIG. 7 is a plan view illustrating operations of the date indicator, the date indicator driving wheel, and the date jumper.

FIG. 8 is a plan view illustrating operations of the date indicator, the date indicator driving wheel, and the date jumper.

FIG. 9 is a plan view illustrating operations of the date indicator, the date indicator driving wheel, and the date jumper.

FIG. 10 is a plan view illustrating operations of the date indicator, the date indicator driving wheel, and the date jumper.

FIG. 11 is a diagram illustrating a rotation angle of the date indicator according to the first embodiment.

FIG. 12 is a diagram illustrating a rotation angle of the date indicator according to a second embodiment.

FIG. 13 is a plan view illustrating a date indicator driving wheel according to a third embodiment.

FIG. 14 is a plan view illustrating a date jumper according to the third embodiment.

FIG. 15 is a plan view illustrating an operation of the date indicator, a date indicator driving wheel, and the date jumper according to the third embodiment.

FIG. 16 is a plan view illustrating operations of the date indicator, the date indicator driving wheel, and the date jumper according to the third embodiment.

FIG. 17 is a plan view illustrating operations of the date indicator, the date indicator driving wheel, and the date jumper according to the third embodiment.

### DESCRIPTION OF EXEMPLARY EMBODIMENTS

### First Embodiment

A watch 1 according to a first embodiment of the present disclosure will be described below with reference to the drawings.

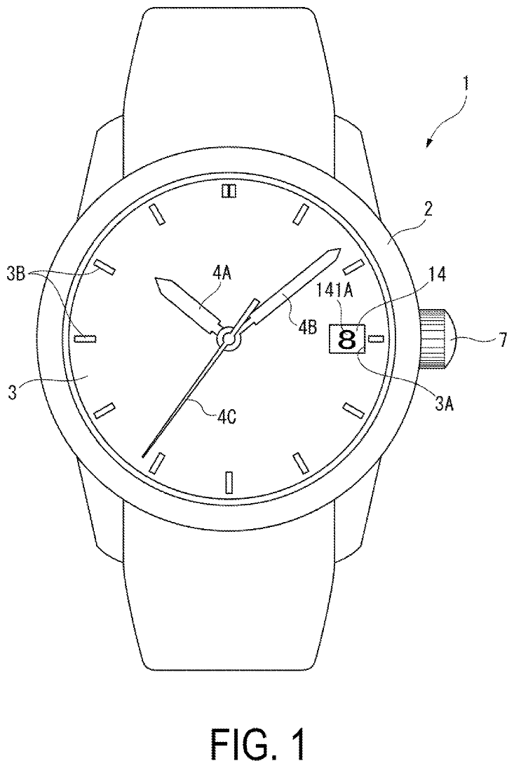

FIG. 1 is a front view illustrating the watch 1.

As illustrated in FIG. 1, the watch 1 is a wrist watch worn on a user's wrist, and is provided with a cylindrical outer case 2, and a dial 3 disposed on an inner circumferential side of the outer case 2. Of two openings in the outer case 2, an opening on the front surface side is blocked by a cover glass, and an opening on the rear side is blocked by a case back.

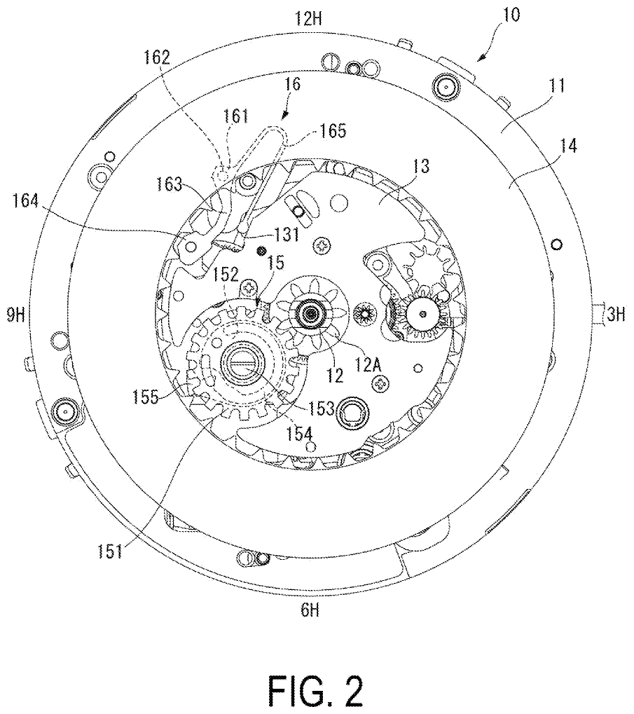

Further, the watch 1 is provided with a movement 10 (FIG. 2) accommodated inside the outer case 2, and an hour hand 4A, a minute hand 4B, and a seconds hand 4C that display time information. A small calendar window 3A is provided in the dial 3, and a numerical character 141A marked on a date indicator 14 is visible from the small calendar window 3A. Further, hour marks 3B used for indicating the time are provided on the dial 3.

A crown 7 is provided on the side surface of the outer case 2. From a zero stage position, in which the crown 7 is pushed in toward the center of the watch 1, the crown 7 can be pulled and moved to a first stage position and a second stage position.

A mainspring (not illustrated) can be wound when the crown 7 is rotated at the zero stage position. When the crown 7 is pulled to the first stage position and rotated, the date indicator 14 is moved to set the date. When the crown 7 is pulled to the second stage position, the seconds hand 4C stops, and when the crown 7 is rotated in the second stage position, the hour hand 4A and the minute hand 4B are moved to set the time. A correction method for the date indicator 14, and the hour hand 4A and the minute hand 4B using the crown 7 is the same as that of a known mechanical clock, and a description thereof will thus be omitted here.

### Movement

FIG. 2 is a plan view illustrating main portions of the movement 10 of the watch 1. Specifically, FIG. 2 is a plan view of the main portions of the movement 10 as viewed from the dial 3 side. Note that in FIG. 2, the numerical character 141A and a friction prevention portion 141B to be described below are omitted from the date indicator 14.

As illustrated in FIG. 2, the movement 10 is configured to include a main plate 11, an hour wheel 12, a date indicator guide plate 13, the date indicator 14, a date indicator driving wheel 15, a date jumper 16, and a train wheel, a mainspring, a barrel, and a date indicator maintaining plate (not illustrated). Note that, in the present embodiment, the movement 10 is configured as a mechanical watch movement provided with a general speed control mechanism.

### Main Plate

The main plate 11 supports the hour wheel 12, the train wheel (not illustrated), the barrel (not illustrated), and the like. Further, in the present embodiment, the date indicator 14 is disposed between the main plate 11 and a date indicator maintaining plate (not illustrated). In this way, the date indicator 14 is held by the main plate 11 and the date indicator maintaining plate, and thus, movement of the date indicator 14 is regulated in the vertical direction.

### Hour Wheel

The hour wheel 12 is configured such that a motive force of the mainspring (not illustrated) is transmitted thereto via the train wheel, such that the hour wheel 12 performs one full rotation in a 12 hour period. Further, in the present embodiment, the hour wheel 12 includes an intermediate date wheel 12A. The intermediate date wheel 12A is configured to engage with a date indicator gear portion 151 of the date indicator driving wheel 15 to be described below. In this way, the rotation of the hour wheel 12 is transmitted to the date indicator driving wheel 15.

### Date Indicator Guide Plate

The date indicator guide plate 13 is disposed on the inner circumferential side of the date indicator 14, and a portion of the date indicator guide plate 13 is in contact with a toothed portion 143 of a date gear portion 142 to be described later. In this way, the date indicator 14 is configured such that movement thereof in the planar direction is regulated by the date indicator guide plate 13 and such that the date indicator 14 rotates along the date indicator guide plate 13.

Further, in the present embodiment, a support face 131, which is in contact with the tip end of a spring portion 165 of the date jumper 16 (to be described below) and which supports the spring portion 165, is provided on the date indicator guide plate 13.

### Date Indicator

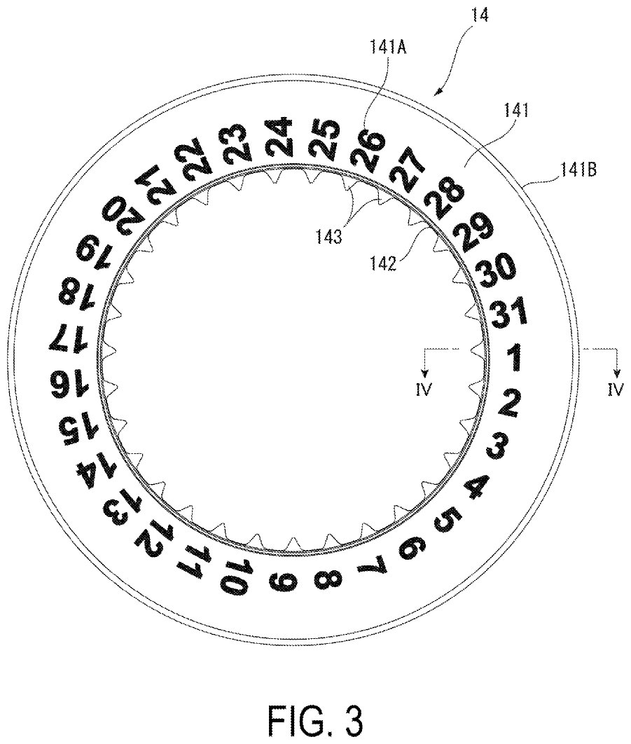

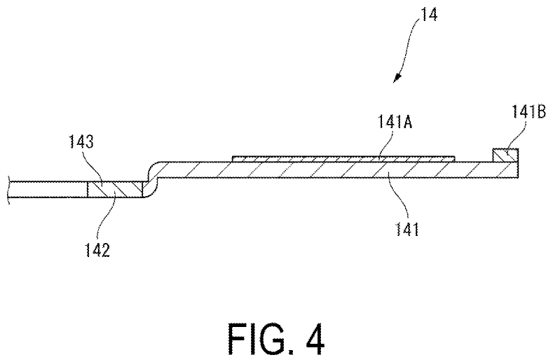

FIG. 3 is a plan view illustrating the date indicator 14 as viewed from the dial 3 side, and FIG. 4 is a cross-sectional view of the date indicator 14 taken along a line IV-IV illustrated in FIG. 3. Note that, for easy of understanding, the numerical character 141A and the rubbing prevention portion 141B are illustrated with exaggerated thickness in FIG. 4.

As illustrated in FIG. 3 and FIG. 4, the date indicator 14 is provided with a calendar plate 141 and the date gear portion 142, and is configured to rotate in the counterclockwise direction as a result of being urged by the date indicator driving wheel 15. The calendar plate 141 is provided in an annular shape, and the numerical character 14A indicating the date and the rubbing prevention unit 141B are provided on a surface on the dial 3 side. In the present embodiment, the rubbing prevention portion 141B is provided in an annular shape along the outer circumferential edge of the calendar plate 141 and protrudes in a direction orthogonal to the calendar plate 141. Further, the numerical character 141A and the rubbing prevention portion 141B are formed by printing.

Note that the numerical character 141A and the rubbing prevention portion 141B are not limited to the above-described configuration, and may be provided, for example, by adhering a sticker or the like. Further, the rubbing prevention portion 141B may be provided between the outer circumferential edge of the calendar plate 141 and the numerical character 141A, for example, and may be configured such that a plurality of protrusions are arranged intermittently.

Here, in the present embodiment, the numerical character 141A and the rubbing prevention portion 141B are provided such that the thickness of the rubbing prevention portion 141B is greater than the thickness of the numerical character 141A in the direction orthogonal to the surface of the calendar plate 141.

In this way, for example, even if a positional relationship between the calendar plate 141 and the dial 3 is displaced due to warping of the calendar plate 141, for example, and the dial 3 comes into contact with the calendar plate 141, the dial 3 comes into contact with the rubbing prevention portion 141B of the calendar plate 141, and thus, it is possible to suppress the dial 3 and the numeral character 141A from coming into contact with each other. As a result, it is possible to suppress the numerical character 141A from being rubbed and becoming difficult to see as a result of the contact between the dial 3 and the numerical character 141A.

The date gear portion 142 is integrally provided with the calendar plate 141 on the inner circumferential side of the calendar plate 141, and includes a plurality of toothed portions 143. In the present embodiment, 31 of the toothed portions 143 are provided on the date gear portion 142. In other words, the date indicator 14 is configured to perform a full rotation at a pitch of 31 that is a meshing pitch of the toothed portions 143, and a pitch angle of the toothed portion 143 is approximately 11.6°. Here, in the present disclosure, the pitch refers to an interval defined by the adjacent toothed portions 143, of the plurality of toothed portions 143. Further, of the adjacent toothed portions 143, the pitch angle refers to an angle formed by a line segment connecting one of the toothed portions 143 to the center of rotation of the date indicator 14, and a line segment connecting the other toothed portion 143 to the center of rotation of the date indicator 14.

Further, the toothed portions 143 are configured to mesh with a date finger 155 of the date indicator driving wheel 15 to be described below, and a jump regulating portion 164 of the date jumper 16. Details of the meshing of the toothed portions 143 with the date finger 155 and the jump regulating portion 164 will be described later.

### Date Indicator Driving Wheel

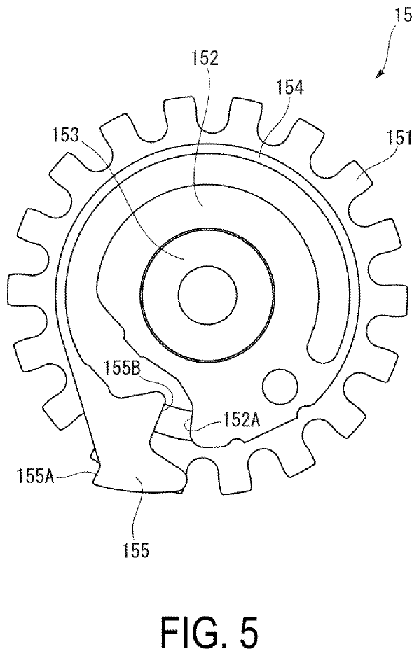

FIG. 5 is a front view illustrating the date indicator driving wheel 15. Note that in FIG. 5, the date indicator driving wheel 15 is viewed from the case back side.

As illustrated in FIG. 5, the date indicator driving wheel 15 is configured to engage with the hour wheel 12 and the date indicator 14 so as to be able to transmit the rotation of the hour wheel 12 to the date indicator 14. In the present embodiment, the date indicator driving wheel 15 includes the date indicator gear portion 151, a date main body portion 152, a date shaft portion 153, an elastic portion 154, and the date finger 155.

The date indicator gear portion 151 is configured to be engageable with the intermediate date wheel 12A of the hour wheel 12, and the rotation of the hour wheel 12 is transmitted to the date indicator gear portion 151.

The date main body portion 152 is disposed on the case back side of the date indicator gear portion 151, and is fixed to the date indicator gear portion 151 by the date shaft portion 153. As a result, the date main body portion 152 is configured to rotate integrally with the date indicator gear portion 151 when the rotation is transmitted from the hour wheel 12 to the date indicator gear portion 151. Further, the date main body portion 152 is provided with a date main body portion engagement face 152A that, when the elastic portion 154 flexes, engages with a second engagement face 155B of the date finger 155 to be described below.

The date shaft portion 153 is a so-called shaft member, and fixes the date indicator gear portion 151 and the date main body portion 152 as described above. In the present embodiment, the date shaft portion 153 is axially supported by the main plate 11. In this way, the date indicator driving wheel 15 is axially supported by the main plate 11.

The elastic portion 154 extends in an arc shape from the date main body portion 152 and is configured to be elastically deformable.

The date finger 155 is provided on the tip end of the elastic portion 154. Then, the date finger 155 includes a first engagement face 155A that engages with the toothed portions 143 of the date indicator 14 and the second engagement face 155B that engages with the above-described date main body portion engagement face 152A.

### Date Jumper

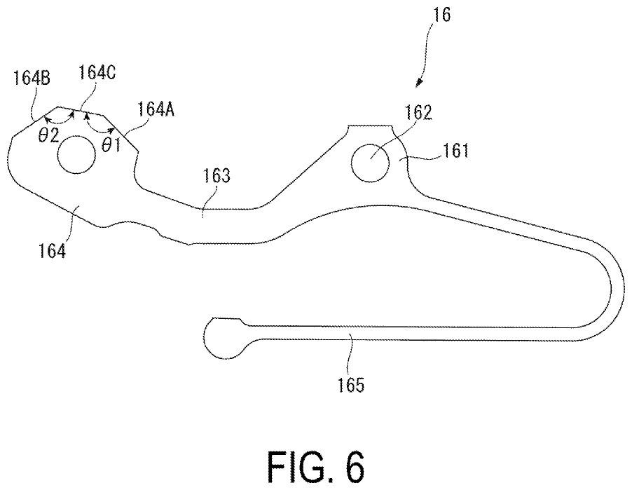

FIG. 6 is a plan view of the date jumper 16 as viewed from the dial 3 side.

As illustrated in FIG. 6, the date jumper 16 regulates the rotation of the date indicator 14, and includes a date jumper base portion 161, a date jumper shaft portion 162, a date jumper arm portion 163, the jump regulating portion 164, and a spring portion 165.

The date jumper base portion 161 is axially supported on the main plate 11 by the date jumper shaft portion 162.

The date jumper shaft portion 162 is axially supported on the main plate 11. Here, in the present embodiment, as illustrated in FIG. 2, the date jumper shaft portion 162 is disposed in a position overlapping with the date indicator 14 in plan view.

The date jumper arm portion 163 is extended from the date jumper base portion 161.

The jump regulating portion 164 is provided at the tip end of the date jumper arm portion 163 and can be engaged with and disengaged from the toothed portions 143 of the date indicator 14.

Further, the jump regulating portion 164 has a first regulating face 164A that engages with one of the adjacent toothed portions 143 and regulates the rotation of the date indicator 14 in the counterclockwise direction, a second regulating face 164B that engages with the other toothed portion 143 and regulates the rotation of the date indicator 14 in the clockwise direction, and a coupling face 164C that is provided between the first regulating face 164A and the second regulating face 164B and that is formed as a flat surface. In the present embodiment, the jump regulating portion 164 is configured such that an angle θ1 of an interior angle formed by the first regulating face 164A and the coupling face 164C is from 130° to 160°, and an angle θ2 of an interior angle formed by the coupling face 164C and the second regulating face 164B is from 120° to 150°.

The spring portion 165 extends in a U shape from the date jumper base portion 161 and is configured to be elastically deformable. In the present embodiment, as described above, the tip end of the spring portion 165 comes into contact with and is supported by the support face 131 of the date indicator guide plate 13.

Further, in the present embodiment, the spring portion 165 is configured to elastically deform in a state in which the jump regulating portion 164 is engaged with the toothed portions 143 of the date indicator 14. In this way, the spring portion 165 urges the jump regulating portion 164 toward the date indicator 14, and the jump regulating portion 164 engages with the toothed portions 143 of the date indicator 14 in order to regulate the rotation of the date indicator 14.

### Operations of Date Indicator, Date Indicator Driving Wheel, and Date Jumper

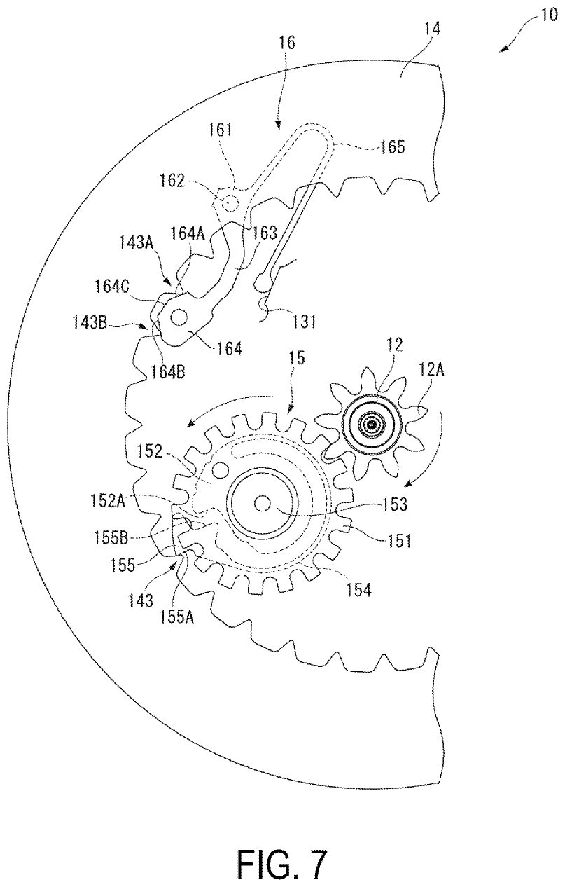

Next, operations of the date indicator 14, the date indicator driving wheel 15, and the date jumper 16 will be described with reference to FIG. 7 to FIG. 10.

As illustrated in FIG. 7, in accordance with the rotation of the hour wheel 12, the date indicator gear portion 151 that is engaged with the intermediate date wheel 12A of the hour wheel 12 rotates in the counterclockwise direction, and the first engagement face 155A of the date finger 155 engages with the toothed portions 143 of the date indicator 14. At this time, as described above, the rotation of the date indicator 14 is regulated by the date jumper 16. Specifically, the rotation of the date indicator 14 is regulated by the engagement between the jump regulating portion 164 of the date jumper 16 and adjacent toothed portions 143A and 143B.

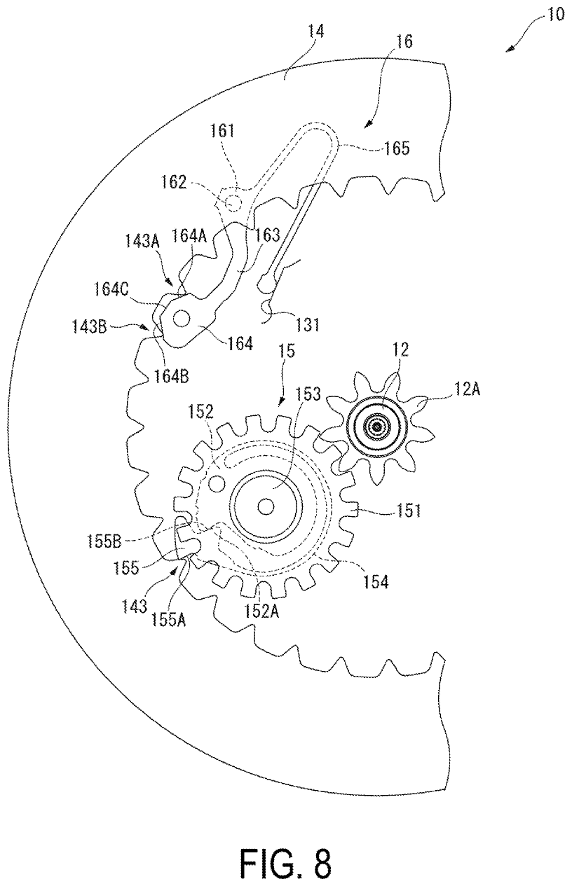

Next, as illustrated in FIG. 8, in the state in which the first engagement face 155A of the date finger 155 and the toothed portion 143 of the date indicator 14 are engaged, when the date indicator driving wheel 15 rotates in accordance with the rotation of the hour wheel 12, the elastic portion 154 gradually flexes. In this way, the urging force that causes the date indicator 14 to rotate in the counterclockwise direction is gradually accumulated in the elastic portion 154 via the date finger 155.

Here, in the present embodiment, in the state in which the jump regulating portion 164 of the date jumper 16 is engaged with the adjacent toothed portions 143A and 143B, the date indicator driving wheel 15 and the date jumper 16 are configured such that a regulating force by which the date jumper 16 regulates the rotation of the date indicator 14 is greater than the urging force with which the elastic portion 154 urges the date indicator 14 in a rotational direction. As a result, the date indicator 14 does not rotate due to the urging force of the elastic portion 154, and the elastic portion 154 continues to flex. Then, when the date indicator driving wheel 15 rotates further, the second engagement face 155B of the date finger 155 comes into contact with the date main body portion engagement face 152A of the date main body portion 152.

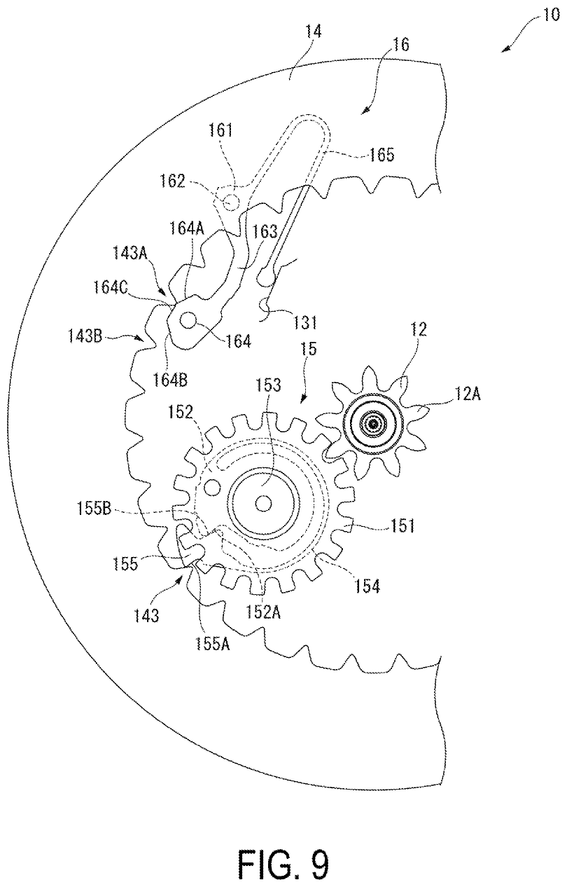

Next, as illustrated in FIG. 9, in the state in which the second engagement face 155B of the date finger 155 and the date main body portion engagement face 152A of the date main body portion 152 are in contact with each other, when the date indicator driving wheel 15 rotates in accordance with the rotation of the hour wheel 12, the rotation of the hour wheel 12 is transmitted to the date indicator 14 via the date finger 155, and thus the date indicator 14 is forcibly rotated in the counterclockwise direction.

In this way, the regulating face 164A of the jump regulating portion 164 is urged by the tooth portion 143A, the spring portion 165 of the date jumper 16 elastically deforms, and the date jumper arm portion 163 rotates in the counterclockwise direction around the date jumper shaft portion 162. Then, a location at which the toothed portion 143A and the first regulating face 164A of the jump regulating portion 164 are in contact with each other, moves over the first regulating face 164A, and reaches an apex between the first regulating face 164A and the coupling face 164C. At this time, the engagement between the other toothed portion 143B and the second regulating face 164B of the jump regulating portion 164 is released. In this way, the engagement state between the jump regulating portion 164 and the toothed portions 143A and 143B is released.

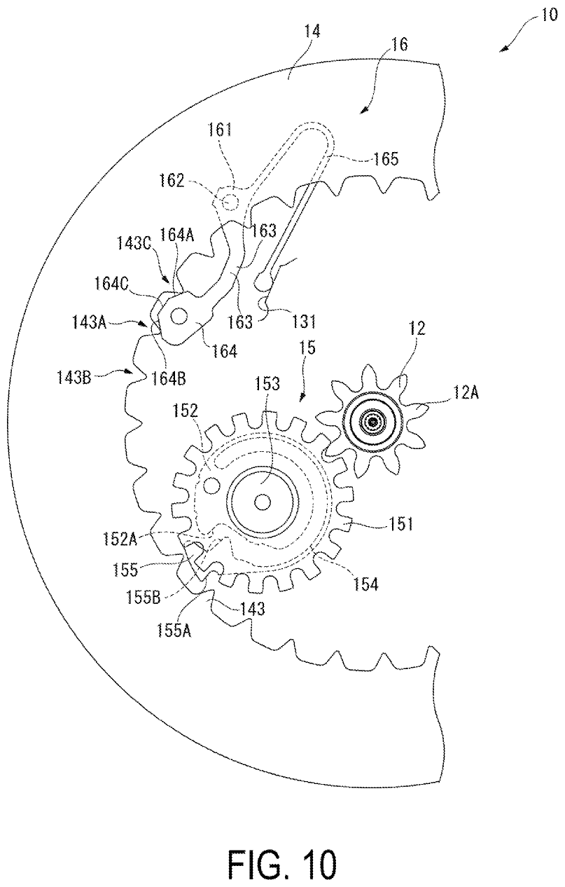

As a result, the regulation of the rotation of the date indicator 14 by the date jumper 16 is released, and thus, as illustrated in FIG. 10, the urging force accumulated in the elastic portion 154 of the date indicator driving wheel 15 is released, and the date indicator 14 instantly rotates in the counterclockwise direction as a result of the urging force.

In this way, the date indicator 14 rotates in a state in which the toothed portion 143A and the coupling face 164C of the jump regulating portion 164 are in contact with each other, and after that, rotates in a state in which the toothed portion 143A and the second regulating face 164B of the jump regulating portion 164 are in contact with each other. At this time, in the state in which the toothed portion 143A and the second regulating face 164B of the jump regulating portion 164 are in contact with each other, the spring portion 165 urges the jump regulating portion 164 toward the date indicator 14. As a result, the date indicator 14 is urged by the date jumper 16, via the second regulating face 164B and the toothed portion 143A, to rotate in the counterclockwise direction

Then, the next adjacent toothed portions 143A and 143C and the jump regulating portion 164 engage with each other, and the rotation of the date indicator 14 is stopped. In other words, the date indicator 14 rotates by one pitch of the meshing between the toothed portions 143 and the jump regulating portion 164. In this way, the date indicator 14 can be rotated by one pitch of the meshing between the toothed portions 143 and the jump regulating portion 164 in a short time period.

### Rotation Angle of Date Indicator

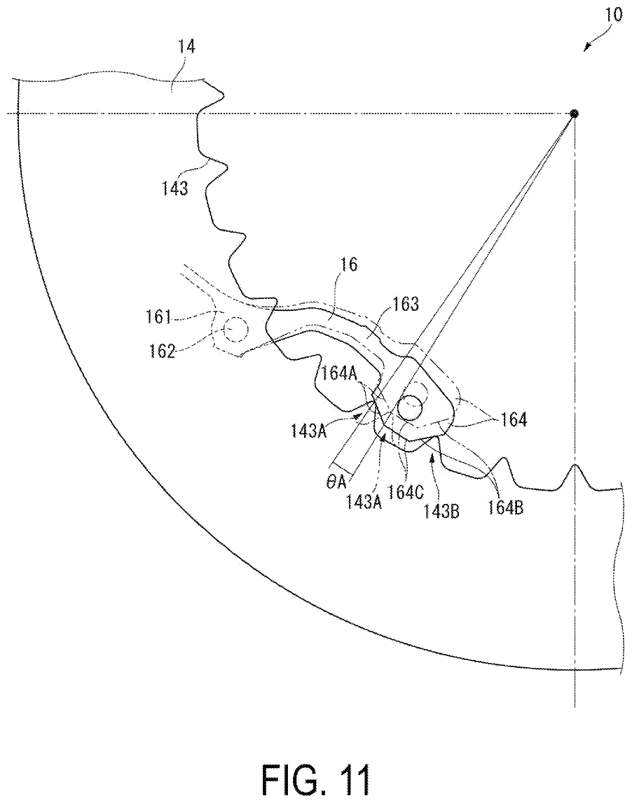

FIG. 11 is a diagram illustrating a rotation angle of the date indicator 14. Note that in FIG. 11, the state in which the toothed portions 143A and 143B of the date indicator 14 and the jump regulating portion 164 of the date jumper 16 are engaged with each other is indicated by solid lines, and the state in which the location of the contact between the toothed portion 143A and the first regulating face 164A reaches the apex between the first regulating face 164A and the coupling face 164C is illustrated by two-dot chain lines.

As described above, the pitch angle of the toothed portions 143 of the date indicator 14 is approximately 11.6°. In other words, the date indicator 14 rotates by approximately 11.6° when rotating by one pitch of the meshing between the toothed portions 143 and the jump regulating portion 164.

In the present embodiment, as illustrated in FIG. 11, a configuration is adopted such that, when the location of the contact between the toothed portion 143A and the first regulating face 164A moves over the top of the first regulating face 164A and reaches the apex of the first regulating face 164A and the coupling face 164C, a rotation angle θA of the date indicator 14 is approximately 3.2°. In other words, the date indicator 14 rotates approximately 3.2° in accordance with the rotation of the hour wheel 12, and after that, instantly rotates 8.4° as a result of the urging force of the elastic portion 154. In this way, in the present embodiment, the rotation angle θA of the date indicator 14 that rotates in the state in which the toothed portion 143A and the first regulating face 164A are in contact with each other is configured to be smaller than the rotation angle of the date indicator 14 in the state in which the toothed portion 143A and the coupling face 164C are in contact with each other, and the state in which the toothed portion 143A and the second regulating face 164B are in contact with each other. As a result, since the time required from when the date indicator 14 starts to rotate to when the toothed portion 143A moves beyond the first regulating face 164A can be shortened, a time period in which a portion of the number 141A marked on the date indicator 14 is displaced from the small calendar window 3A can be shortened, and a deterioration in the appearance can be suppressed.

Here, in the present embodiment, as described above, the angle of the first regulating face 164A is made steeper in order to shorten the time from when the date indicator 14 starts to rotate until the toothed portion 143A moves beyond the first regulating face 164A. Specifically, as described above, the jump regulating portion 164 is configured such that the angle θ1 of the interior angle formed by the first regulating face 164A and the coupling face 164 C is from 130° to 160°.

At this time, in the present embodiment, the jump regulating portion 164 is configured to include the first regulating face 164A, the second regulating face 164B, and the coupling face 164C. Thus, even when the angle of the first regulating face 164A is made steeper, it is not necessary to make the angle of the second regulating face 164B less acute. In other words, even when an angle of the first regulating face 164A with respect to a tangent of a circle drawn by the trajectory of the tip end of the toothed portion 143A is made larger, it is not necessary to reduce an angle of the second regulating face 164B with respect to a tangent of a circle drawn by the trajectory of the tip end of the toothed portion 143B. Specifically, when the angle of the first regulating face 164A is configured as described above, the angle θ2 of the interior angle formed by the coupling face 164C and the second regulating face 164B can be configured to be from 120° to 150°. As a result, the time period from when the date indicator 14 starts to rotate to when the toothed portion 143A moves beyond the first regulating face 164A can be shortened without weakening the regulating force by which the jump regulating portion 164 regulates the rotation of the date indicator 14.

### Advantageous Effects of First Embodiment

In the first embodiment as described above, the following advantageous effects can be obtained.

In the present embodiment, the movement 10 is provided with the hour wheel 12, the date indicator 14, the date indicator driving wheel 15, and the date jumper 16. Then, the jump regulating portion 164 of the date jumper 16 includes the first regulating face 164A that engages with the toothed portion 143A that is one of the adjacent toothed portions 143A and 143B of the date indicator 14, the second regulating face 164B that engages with the other toothed portion 143B, and the coupling face 164C provided between the first regulating face 164A and the second regulating face 164B, and the jump regulating portion 164 is configured to be able to engage with and disengage from the adjacent toothed portions 143A and 143B. Then, in accordance with the rotation of the hour wheel 12 transmitted by the date indicator driving wheel 15, the date indicator 14 rotates in the state in which the toothed portion 143A and the first regulating face 164A are in contact with each other. After that, the date indicator 14 rotates in accordance with the urging force of the elastic portion 154 of the date indicator driving wheel 15, in the state in which the toothed portion 143A and the coupling face 164C are in contact with each other. After that, as a result of rotating in the state in which the toothed portion 143A and the second regulating face 16B are in contact with each other, the date indicator 14 rotates by one pitch of the meshing between the toothed portions 143 and the jump regulating portion 164.

In this way, even when the angle of the first regulating face 164A is made steeper, it is not necessary to make the angle of the second regulating face 164B less acute, and thus, the time period from when the date indicator 14 starts rotating to when the toothed portion 143A moves beyond the first regulating face 164A can be shortened without weakening the regulating force by which the jump regulating portion 164 regulates the rotation of the date indicator 14. Thus, the date can be switched in a short time period, and inadvertent rotation of the date indicator 14 can be suppressed.

In the present embodiment, in the state in which the jump regulating portion 164 is engaged with the adjacent toothed portions 143A and 143B, the regulating force by which the date jumper 16 regulates the rotation of the date indicator 14 is greater than the urging force by which the elastic portion 154 urges the date indicator 14 in the rotational direction.

As a result, since the regulation of the date indicator 14 by the date jumper 16 is not disengaged by the urging force of the elastic portion 154, the date indicator 14 can be reliably rotated by one pitch at a desired timing.

In the present embodiment, the rotation angle θA of the date indicator 14 over which the date indicator 14 rotates in the state in which the toothed portion 143A and the first regulating face 164A are in contact with each other, is smaller than the rotation angle of the date indicator 14 over which the date indicator 14 rotates in the state in which the tooth portioned 143A and the second regulating face 164B are in contact with each other.

As a result, since the time required from when the date indicator 14 starts to rotate to when the toothed portion 143A moves beyond the first regulating face 164A can be shortened, the time period in which a portion of the number 141A marked on the date indicator 14 is displaced from the small calendar window 3A can be shortened.

In the present embodiment, in plan view, the angle θ1 of the interior angle formed by the first regulating face 164A and the coupling face 164C is from 130° to 160°, and the angle θ2 of the interior angle formed by the coupling face 164C and the second regulating face 164B is from 120° to 150°.

Thus, the date can be switched in a short time period, and the inadvertent rotation of the date indicator 14 can be suppressed.

In the present embodiment, the date indicator 14 includes the rubbing prevention portion 141B that is provided on the surface of the calendar plate 141 on which the numerical character 141A is marked, and that protrudes in the direction orthogonal to the calendar plate 141.

Thus, for example, even if the positional relationship between the calendar plate 141 and the dial 3 is displaced due to warping of the calendar plate 141 and the dial 3 comes into contact with the calendar plate 141, since the dial 3 comes into contact with the rubbing prevention portion 141B of the calendar plate 141, it is possible to suppress the numerical character 141A from being rubbed and becoming difficult to see as a result of the contact between the dial 3 and the numerical character 141A.

### Second Embodiment

Next, a movement 20 according to a second embodiment of the present disclosure will be described below with reference to the drawings.

The movement 20 according to the second embodiment differs from the above-described first embodiment in that, in plan view, a date jumper shaft portion 262 of a date jumper 26 is disposed on the inner circumferential side of the date indicator 14. Note that components of the second embodiment that are identical or similar to the corresponding components of the first embodiment are denoted by identical reference signs and that a description of these components is omitted.

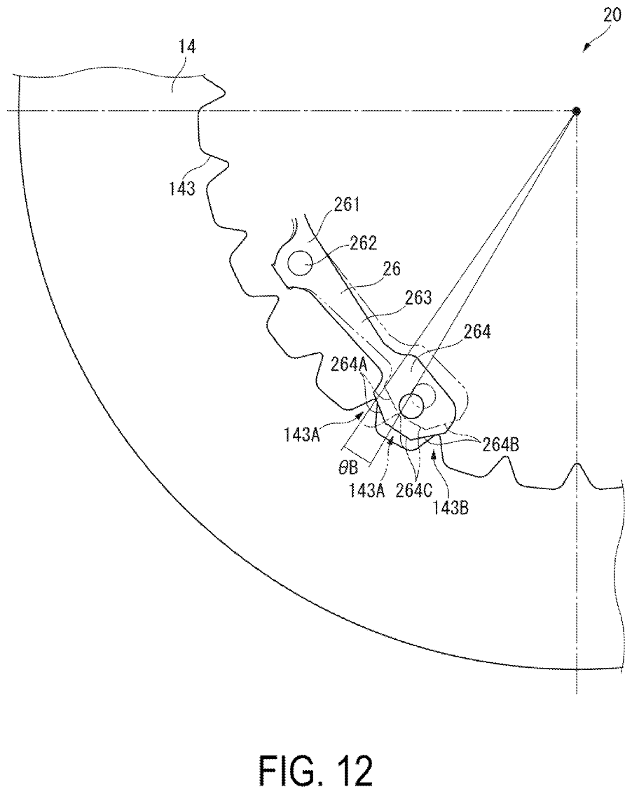

FIG. 12 is a diagram illustrating a rotation angle of the date indicator 14 according to the second embodiment. Note that in FIG. 12, a state in which the toothed portions 143A and 143B of the date indicator 14 and a jump regulating portion 264 of the date jumper 26 are engaged is indicated by solid lines, and a state in which a location of contact between the toothed portion 143A and a first regulating face 264A reaches an apex between the first regulating face 264A and a coupling face 264C is illustrated by two-dot chain lines.

In the present embodiment, in a similar manner to the above-described first embodiment, the pitch angle of the toothed portions 143 of the date indicator 14 is approximately 11.6°. That is, the date indicator 14 rotates by approximately 11.6° when rotating by one pitch of the meshing between the toothed portions 143 and the jump regulating portion 264.

Then, in the present embodiment, the date jumper shaft portion 262 of the date jumper 26 is disposed on the inner circumferential side of the date indicator 14 in plan view. In other words, in plan view, a date jumper base portion 261, the date jumper shaft portion 262, a date jumper arm portion 263, and the jump regulating portion 264 that configure the date jumper 26 are disposed in positions that do not overlap with the date indicator 14. As a result, for example, when the date jumper 26 is replaced or the position thereof is finely adjusted, such as during maintenance, each of the components of the date jumper 26 is visible without removing the date indicator 14, and replacement or adjustment operations can thus be made easier.

Here, in the present embodiment, as illustrated in FIG. 12, a configuration is adopted such that, when the location of the contact between the toothed portion 143A and the first regulating face 264A moves over the top of the first regulating face 264A and reaches the apex between the first regulating face 264A and the coupling face 264C, a rotation angle θB of the date indicator 14 is approximately 4.5° In other words, the date indicator 14 rotates approximately 4.5° in accordance with the rotation of the hour wheel 12, and after that, instantly rotates 7.1° as a result of the urging force of the elastic portion 154. In this way, in the present embodiment also, the rotation angle θB of the date indicator 14 over which the date indicator rotates in the state in which the toothed portion 143A and the first regulating face 264A are in contact is configured to be smaller than a rotation angle of the date indicator 14 over which the date indicator 14 rotates in a state in which the toothed portion 143A and a second regulating face 264B are in contact with each other. As a result, since the time required from when the date indicator 14 starts to rotate to when the toothed portion 143A moves beyond the first regulating face 264A can be shortened, a time period in which a portion of the number 141A marked on the date indicator 14 is displaced from the small calendar window 3A can be shortened, and a deterioration in the appearance can be suppressed.

Note that, when the date jumper shaft portion 162 of the date jumper 16 is disposed in a position overlapping with the date indicator 14, as in the above-described first embodiment, the rotation angle θA of the date indicator 14 over which the date indicator 14 rotates in the state in which the toothed portion 143A and the first regulating face 164A are in contact with each other becomes smaller, and thus the time period over which a portion of the numerical character 141A marked on the date indicator 14 is displaced from the small calendar window 3A can be shortened.

### Advantageous Effects of Second Embodiment

In the second embodiment as described above, the following advantageous effects can be obtained.

In the present embodiment, the date jumper shaft portion 262 of the date jumper 26 is disposed on the inner circumferential side of the date indicator 14 in plan view. Thus, the date jumper shaft portion 262 is visible without removing the date indicator 14, and replacement or adjustment operations of the date jumper 26 can thus be made easier.

### Third Embodiment

Next, a movement 30 according to a third embodiment of the present disclosure will be described below with reference to the drawings.

The movement 30 according to the third embodiment differs from the first embodiment and the second embodiment in that an engagement protrusion 352B is formed on a date main body portion engagement face 352A of a date main body portion 352, and an engagement recess 355C is formed in a second engagement face 355B of a date finger 355. Note that components of the third embodiment that are identical or similar to the corresponding components of the first and second embodiments are denoted by identical reference signs and that a description of these components is omitted.

### Date Indicator Driving Wheel

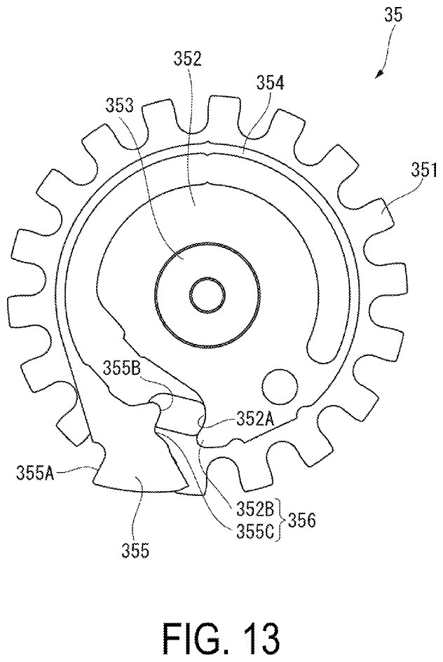

FIG. 13 is a front view illustrating a date indicator driving wheel 35. Note that in FIG. 13, the date indicator driving wheel 35 is viewed from the case back side.

As illustrated in FIG. 13, in a similar manner to the date indicator driving wheel 15 of the above-described first embodiment, the date indicator driving wheel 35 according to the present embodiment is configured to engage with the hour wheel 12 and the date indicator 14 so as to be able to transmit the rotation of the hour wheel 12 to the date indicator 14. In the present embodiment, the date indicator driving wheel 35 is provided with a date indicator gear portion 351, a date main body portion 352, a date shaft portion 353, an elastic portion 354, and the date finger 355. Note that the date indicator gear portion 351, the date shaft portion 353, and the elastic portion 354 are the same as in the above-described first embodiment, and a description thereof will thus be omitted here.

The date main body portion 352 is disposed on the case back side of the date indicator gear portion 351, and is fixed to the date indicator gear portion 351 by the date shaft portion 353. Further, the date main body portion 352 is provided with the date main body portion engagement face 352A that, when the elastic portion 354 flexes, engages with the second engagement face 355B of the date finger 355, which will be described below. Then, in the present embodiment, the engagement protrusion 352B that protrudes toward the date finger 355 is formed on the date main body portion engagement face 352A. The engagement protrusion 352B is formed so as to engage with the engagement recess 355C formed in the date finger 355 described below, when the elastic portion 354 flexes and the second engagement face 355B and the date main body portion engagement face 352A are engaged with each other.

The date finger 355 is provided on the tip end of the elastic portion 354, and includes a first engagement face 355A that engages with the toothed portions 143 of the date indicator 14, and the second engagement face 355B that engages with the above-described date main body portion engagement face 352A. Then, in the present embodiment, the engagement recess 355C that can engage with the above-described engagement protrusion 352B is formed in the second engagement face 355B.

### Date Jumper

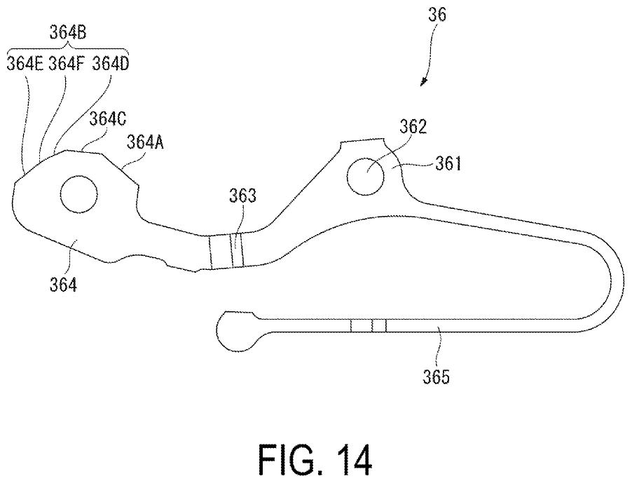

FIG. 14 is a plan view of a date jumper 36 as viewed from the dial 3 side.

As illustrated in FIG. 14, the date jumper 36 regulates the rotation of the date indicator 14, and includes a date jumper base portion 361, a date jumper shaft portion 362, a date jumper arm portion 363, a jump regulating portion 364, and a spring portion 365. Note that the date jumper base portion 361, the date jumper shaft portion 362, the date jumper arm portion 363, and the spring portion 365 are the same as in the above-described first embodiment, and a detailed description thereof will thus be omitted here.

The jump regulating portion 364 is provided at the tip end of the date jumper arm portion 363 and can be engaged with and disengaged from the toothed portions 143 of the date indicator 14.

Further, the jump regulating portion 364 has a first regulating face 364A that engages with one of the adjacent toothed portions 143 and regulates the rotation of the date indicator 14 in the counterclockwise direction, a second regulating face 364B that engages with the other toothed portion 143 and regulates the rotation of the date indicator 14 in the clockwise direction, and a coupling face 364C that is provided between the first regulating face 364A and the second regulating face 364B and that is formed as a flat surface. Then, in the present embodiment, the second regulating face 364B includes two flat surface portions 364D and 364E, and a curved surface portion 364F that couples the two flat surface portions 364D and 364E.

### Operations of Date Indicator, Date Indicator Driving Wheel, and Date Jumper

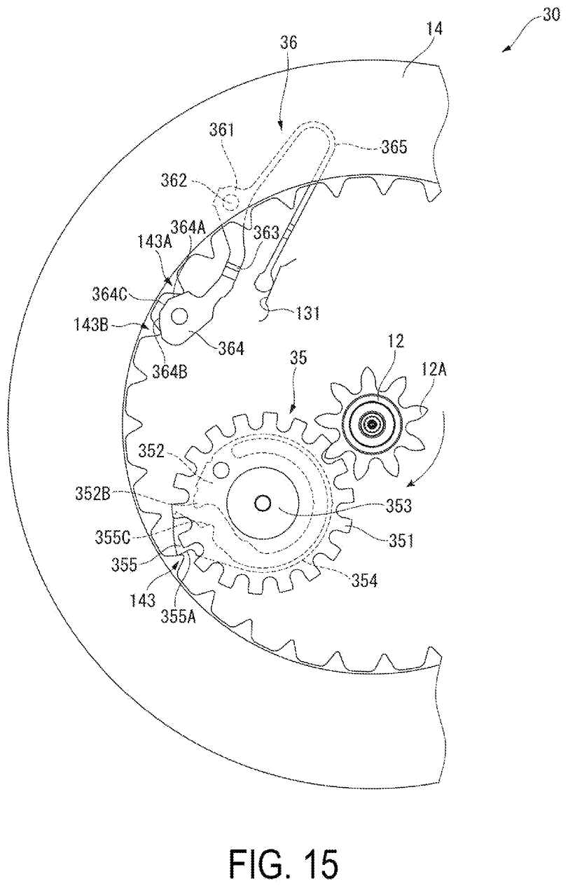

Next, operations of the date indicator 14, the date indicator driving wheel 35, and the date jumper 36 will be described with reference to FIG. 15 to FIG. 17.

As illustrated in FIG. 15, in a similar manner to the above-described first embodiment, in accordance with the rotation of the hour wheel 12, the date drive gear unit 351 that is engaged with the intermediate gear wheel 12A of the hour wheel 12 rotates in the counterclockwise direction, and the first engagement face 355A of the date finger 355 engages with the toothed portions 143 of the date indicator 14. At this time, the rotation of the date indicator 14 is regulated by the date jumper 36. Specifically, the rotation of the date indicator 14 is regulated by the engagement between the jump regulating portion 364 of the date jumper 36 and the adjacent toothed portions 143A and 143B.

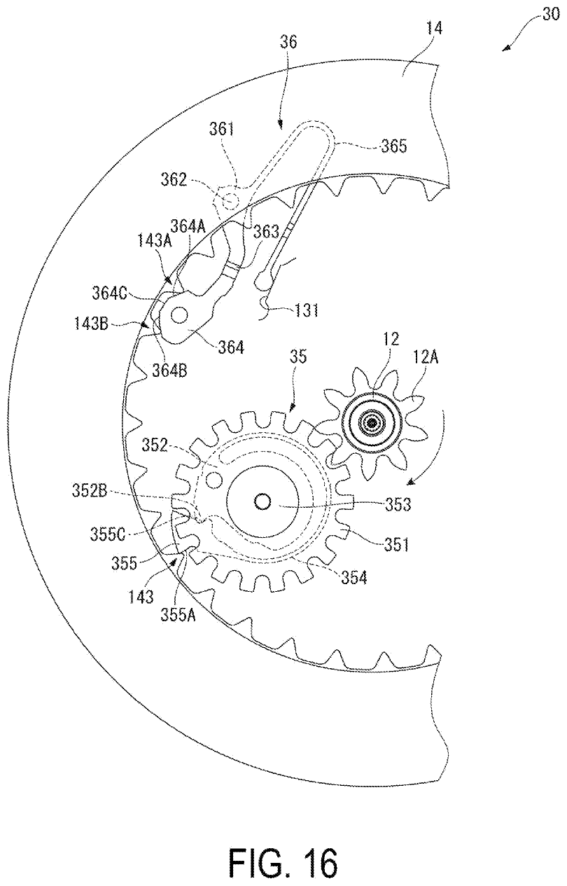

Next, as illustrated in FIG. 16, in the state in which the first engagement face 355A of the date finger 355 and the toothed portion 143 of the date indicator 14 are engaged, the elastic portion 354 gradually flexes. In this way, the urging force that causes the date indicator 14 to rotate in the counterclockwise direction is gradually accumulated in the elastic portion 354 via the date finger 355. Then, when the date indicator driving wheel 35 rotates further, the second engagement face 355B of the date finger 355 engages with the date main body portion engagement face 352A of the date main body portion 352. At this time, in the present embodiment, as described above, the engagement protrusion 352B formed on the date main body portion engagement face 352A is engaged with the engagement recess 355C formed in the second engagement face 355B of the date finger 355. In this way, the movement of the date finger 355 with respect to a direction along a tangent line of a rotation trajectory of the date indicator driving wheel 35 is regulated, and at the same time, the movement of the date finger 355 in a direction orthogonal to the tangent line of the rotation trajectory of the date indicator driving wheel 35, that is, the movement of the date finger 355 with respect to a direction toward the center of rotation of the date indicator driving wheel 35, is also regulated. In other words, the engagement protrusion 352B and the engagement recess 355C configure a movement regulation unit 356 of the present disclosure that regulates the movement of the date finger 355 in the direction along the tangent line of the rotation trajectory of the date indicator driving wheel 35, and in the direction orthogonal to the tangent line.

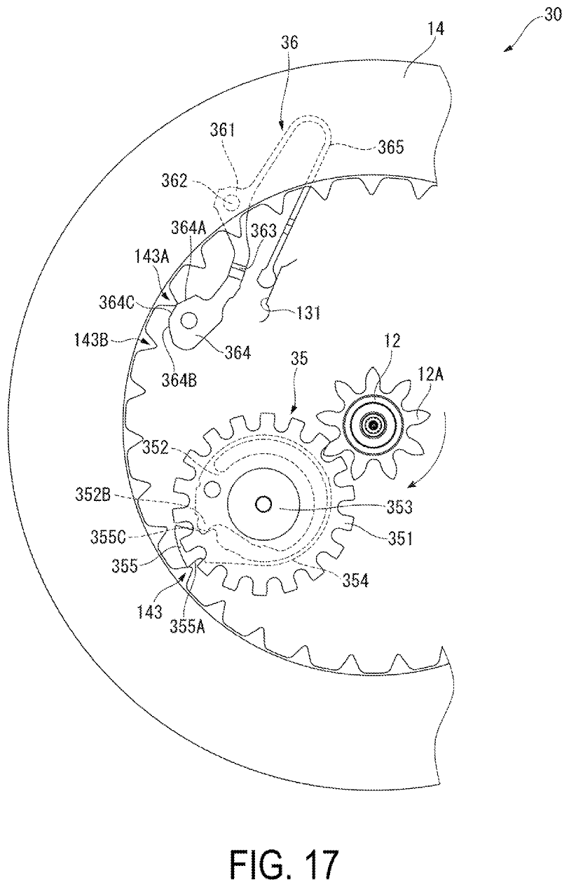

Next, as illustrated in FIG. 17, in the state in which the second engagement face 355B of the date finger 355 and the date main body portion engagement face 352A of the date main body portion 352 are engaged with each other, when the date indicator driving wheel 35 rotates in accordance with the rotation of the hour wheel 12, the rotation of the hour wheel 12 is transmitted to the date indicator 14 via the date finger 355, and thus, the date indicator 14 is forcibly rotated in the counterclockwise direction.

In this way, the first regulating face 364A of the jump regulating portion 364 is urged by the toothed portion 143A, the spring portion 365 of the date jumper 36 elastically deforms, and the date jumper arm portion 363 rotates in the counterclockwise direction about the date jumper shaft portion 362. Then, a location at which the toothed portion 143A and the first regulating face 364A of the jump regulating portion 364 are in contact with each other, moves over the first regulating face 364A, and reaches an apex between the first regulating face 364A and the coupling face 364C. At this time, the engagement between the other toothed portion 143B and the second regulating face 364B of the jump regulating portion 364 is released. In this way, the engagement state between the jump regulating portion 364 and the toothed portions 143A and 143B is released.

As a result, the regulation of the rotation of the date indicator 14 by the date jumper 36 is released, and thus, in a similar manner to the above-described first embodiment, the date indicator 14 rotates by one pitch of the meshing.

### Advantageous Effects of Third Embodiment

In the third embodiment as described above, the following advantageous effects can be obtained.

In the present embodiment, the date drive vehicle 35 includes the movement regulation unit 356 that regulates the movement of the date finger 355 with respect to the direction along the tangent line of the rotation trajectory of the date indicator driving wheel 35, and regulates the movement of the date finger 355 with respect to the direction orthogonal to the tangent line.

In this way, when the date finger 355 and the date main body portion 352 come into contact with each other, the movement of the date finger 355 with respect to the direction orthogonal to the tangent of the rotation regulation of the lead vehicle 35 can be regulated. As a result, it is possible to suppress the date finger 355 from moving in the direction orthogonal to the above-described tangent line, namely, in the direction toward the center of rotation of the date indicator driving wheel 35, and thus inhibit the engagement state between the date finger 355 and the toothed portions 143 of the date indicator 14 from being released. Thus, the date indicator 14 can be more reliably rotated by the date finger 355.

In the present embodiment, the movement regulation unit 356 is configured to include the engagement protrusion 352B formed on the date main body portion 352 and the engagement recess 355C formed in the date finger 355.

In this way, the movement of the date finger 355 with respect to the two directions can be regulated simultaneously by the engaging protrusion 352B formed on the date main body portion 352 and the engagement recess 355C formed in the date finger 355. As a result, the structure of the movement regulation unit 356 that regulates the movement of the date finger 355 can be made simple.

### MODIFIED EXAMPLES

Note that the present disclosure is not limited to each of the above-described embodiments, and variations, modifications, and the like within the scope in which the object of the present disclosure can be achieved are included in the present disclosure.

In each of the above-described embodiments, each of the movements 10, 20, and 30 is configured as a movement of a mechanical clock provided with a general speed adjustment mechanism, but the configuration is not limited thereto. For example, the movement may be configured as a movement of an electronically controlled mechanical clock provided with a generator or the like.

In each of the above-described embodiments, the calendar plate 141 of the date indicator 14 is provided with the rubbing prevention portion 141B, but the configuration is not limited thereto, and a case in which a rubbing prevention member is not provided on the calendar plate is also included in the present disclosure.

In each of the above-described embodiments, each of the movements 10, 20, and 30 is configured to include the date indicator 14 on which the numerical character 141A indicating the date is marked, but the configuration is not limited thereto. For example, in addition to the date indicator 14, the movement may be configured to include a day indicator on which a letter indicating a day of the week is indicated. In this case, the movement may be configured to include a day indicator driving wheel that rotates the day indicator, and a day jumper that regulates the rotation of the day indicator.

In each of the above-described embodiments, the 31 toothed portions 143 are provided on the date gear portion 142 of the date indicator 14, and the pitch angle of the toothed portions 143 is approximately 11.6°, but the configuration is not limited thereto. For example, in the case of a big date display, in which the tens place and the units place of the date are respectively displayed by numbers marked on separate date indicators, the toothed portions may be provided corresponding to the number marked on each of the date indicators. In this case, the pitch angle of each of the date indicators is an angle corresponding to the number of toothed portions of each of the date indicators.

In the above-described third embodiment, the engagement protrusion 352B is formed on the date main body portion 352 of the date indicator driving wheel 35, and the engagement recess 355C is formed in the drive finger 355. However, the configuration of the third embodiment is not limited thereto. For example, an engagement recess may be formed in the date main body portion, and an engagement protrusion may be formed on the date finger. Furthermore, a configuration may be adopted in which engagement step portions that are engageable with each other are formed on both the date main body portion and the date finger, such that both the movement of the date finger with respect to the direction along the tangent line of the rotation trajectory of the date indicator driving wheel and the movement of the date finger with respect to the direction orthogonal to the tangent line can be regulated.

### CONCLUSION OF PRESENT DISCLOSURE

A movement according to an aspect of the present disclosure includes an hour wheel, and a date indicator including a calendar plate provided in an annular shape and on which is marked a numeral character indicating a date and a date gear portion including a plurality of toothed portions provided on an inner circumferential side of the calendar plate. The movement includes a date indicator driving wheel including a date indicator gear portion configured to engage with the hour wheel and to which rotation of the hour wheel is transmitted, a date main body portion configured to rotate integrally with the date indicator gear portion, an elastic portion extending from the date main body portion and configured to urge the date indicator in a rotational direction, and a date finger provided on a tip end of the elastic portion and configured to engage with the toothed portion of the date gear portion. The movement includes a date jumper including a jump regulating portion configured to engage with adjacent toothed portions, of the plurality of toothed portions, to regulate rotation of the date indicator. The jump regulating portion includes a first regulating face that, of the adjacent toothed portions, engages with one of the toothed portions, a second regulating face that engages with the other of the toothed portions, and a coupling face provided between the first regulating face and the second regulating face, the jump regulating portion being configured to engage with and disengage from the adjacent toothed portions. The date indicator rotates by one pitch of meshing between the toothed portions and the jump regulating portion, by rotating, in accordance with the rotation of the hour wheel transmitted by the date indicator driving wheel, in a state in which the one of the toothed portions and the coupling face are in contact with each other, subsequently rotating, in accordance with an urging force of the elastic portion, in a state in which the one of the toothed portions and the coupling face are in contact with each other, and further subsequently rotating in a state in which the one of the toothed portions and the second regulating face are in contact with each other.

In this way, even when the angle of the first regulating face is made steeper, it is not necessary to make the angle of the second regulating face less acute, and thus, a time period from when the date indicator starts rotating to when the toothed portion moves beyond the first regulating face can be shortened without weakening a regulating force by which the jump regulating portion regulates the rotation of the date indicator. Thus, the date can be switched in a short time period, and inadvertent rotation of the date indicator can be suppressed.

In the movement according to the aspect of the present disclosure, in a state in which the jump regulating portion is engaged with the adjacent toothed portions, a regulating force by which the date jumper regulates the rotation of the date indicator is preferably greater than the urging force by which the elastic portion urges the date indicator in the rotational direction.

In this way, since the regulation of the date indicator by the date jumper is not disengaged by the urging force of the elastic portion, the date indicator can be reliably rotated by one pitch at a desired timing.

In the movement according to the aspect of the present disclosure, a rotation angle over which the date indicator rotates in the state in which the one of the toothed portions and the first regulating face are in contact with each other is preferably smaller than a rotation angle over which the date indicator rotates in the state in which the one of the toothed portions and the coupling face are in contact with each other and in the state in which the one of the toothed portions and the second regulating face are in contact with each other.

In this way, a time period from when the date indicator starts to rotate to when the toothed portion moves beyond the first regulating face can be shortened.

In the movement according to the aspect of the present disclosure, in plan view, an angle of an interior angle formed by the first regulating face and the coupling face is preferably from 130° to 160°, and an angle of an interior angle formed by the coupling face and the second regulating face is preferably from 120° to 150°.

In the movement according to the aspect of the present disclosure, the date indicator preferably includes a rubbing prevention portion that is provided on a surface of the calendar plate on which the numerical character is marked, and that protrudes in a direction orthogonal to the calendar plate.

In this way, for example, even when a positional relationship between the calendar plate and the dial is displaced due to warping of the calendar plate and the dial comes into contact with the calendar plate, the dial comes into contact with the rubbing prevention portion of the calendar plate. As a result, it is possible to suppress the numerical character from being rubbed and becoming difficult to see as a result of the contact between the dial and the numerical character.

In the movement according to the aspect of the present disclosure, the date indicator driving wheel preferably includes a movement regulation unit that regulates movement of the date finger with respect to a direction along a tangent line of a rotation trajectory of the date indicator driving wheel, and movement of the date finger with respect to a direction orthogonal to the tangent line.

In this way, the movement of the date finger with respect to the direction orthogonal to the tangent line of the rotation trajectory of the date indicator driving wheel can be regulated when the date finger and the date main body portion come into contact with each other. As a result, it is possible to suppress the date finger from moving in the above-described direction orthogonal to the tangent line, namely, in a direction toward the center of rotation of the date indicator driving wheel, and thus inhibit the engagement state between the date finger and the toothed portions of the date indicator from being released. Thus, the date indicator can be more reliably rotated by the date finger.

In the movement according to the aspect of the present disclosure, the movement regulation portion is preferably configured to include an engagement protrusion formed on the date main body portion and an engagement recess formed in the date finger.

In this way, the movement of the date finger with respect to the two directions can be regulated simultaneously by the engagement protrusion formed on the date main body portion and the engagement recess formed in the date finger. As a result, the structure of the movement regulation unit that regulates the movement of the date finger can be made simple.

A watch according to an aspect of the present disclosure includes the above-described movement.

What is claimed is:

1. A movement comprising:
an hour wheel;
a date indicator including a calendar plate provided in an annular shape and at which is marked a numeral character indicating a date, and a date gear portion including a plurality of toothed portions provided at an inner circumferential side of the calendar plate;
a date indicator driving wheel including a date indicator gear portion configured to engage with the hour wheel and to which rotation of the hour wheel is transmitted, a date main body portion configured to rotate integrally with the date indicator gear portion, an elastic portion extending from the date main body portion and configured to urge the date indicator in a rotational direction, and a date finger provided at a tip end of the elastic portion and configured to engage with the toothed portion of the date gear portion; and
a date jumper including a jump regulating portion configured to engage with adjacent toothed portions, of the plurality of toothed portions, to regulate rotation of the date indicator, wherein
the jump regulating portion includes a first regulating face that engages with one of the adjacent toothed portions, a second regulating face that engages with the other of the toothed portions, and a coupling face provided between the first regulating face and the second regulating face, the jump regulating portion being configured to be engageable with and disengageable from the adjacent toothed portions, and
the date indicator rotates by one pitch of meshing between the toothed portions and the jump regulating portion, by rotating, in accordance with the rotation of the hour wheel transmitted by the date indicator driving wheel, in a state in which the one of the toothed portions and the coupling face are in contact with each other, subsequently rotating, in accordance with an urging force of the elastic portion, in a state in which the one of the toothed portions and the coupling face are in contact with each other, and further subsequently rotating in a state in which the one of the toothed portions and the second regulating face are in contact with each other.

2. The movement according to claim 1, wherein
in a state in which the jump regulating portion is engaged with the adjacent toothed portions, a regulating force by which the date jumper regulates the rotation of the date indicator is greater than the urging force by which the elastic portion urges the date indicator in the rotational direction.

3. The movement according to claim 1, wherein
a rotation angle over which the date indicator rotates in the state in which the one of the toothed portions and the first regulating face are in contact with each other is smaller than a rotation angle over which the date indicator rotates in the state in which the one of the toothed portions and the coupling face are in contact with each other and in the state in which the one of the toothed portions and the second regulating face are in contact with each other.

4. The movement according to claim 1, wherein
in plan view, an angle of an interior angle formed by the first regulating face and the coupling face is from 130° to 160°, and an angle of an interior angle formed by the coupling face and the second regulating face is from 120° to 150°.

5. The movement according to claim 1, wherein
the date indicator includes a rubbing prevention portion that is provided at a surface of the calendar plate at which the numerical character is marked, and that protrudes in a direction orthogonal to the calendar plate.

6. The movement according to claim 1, wherein
the date indicator driving wheel includes a movement regulation unit that regulates movement of the date finger with respect to a direction along a tangent line of a rotation trajectory of the date indicator driving wheel, and movement of the date finger with respect to a direction orthogonal to the tangent line.

7. The movement according to claim 6, wherein
the movement regulation portion is configured to include an engagement protrusion formed at the date main body portion and an engagement recess formed at the date finger.

8. A watch comprising:
the movement according to claim 1.
